(19) United States
(12) Patent Application Publication
(10) Pub. No.: US 2012/0214373 A1
(43) Pub. Date: Aug. 23, 2012

(54) Method of Indirect Application of Frothed Chemistry to a Substrate

(76) Inventors: Deborah Joy Calewarts, Appleton, WI (US); Jian Qin, Appleton, WI (US); Jeffrey F. Jurena, Appleton, WI (US); Donald E. Waldroup, Roswell, GA (US); Stephen M. Campbell, Winneconne, WI (US)

(21) Appl. No.: 13/461,536

(22) Filed: May 1, 2012

Related U.S. Application Data
(63) Continuation of application No. 12/979,852, filed on Dec. 28, 2010.

(51) Int. Cl. B32B 5/24; B32B 5/02

(52) U.S. Cl. 442/76; 442/59; 442/153

(57) ABSTRACT

Substrates such as tissue and nonwovens have an additive composition applied topically thereto. The additive composition, for instance, comprises a frothed aqueous dispersion or solution which is topically applied to the web through a creping process after the web has been formed. The additive composition may be applied in-line to the web as a creping adhesive during a creping operation. In the alternative, the additive composition may be added in an off-line converting process that crepes a dry pre-formed substrate material. The additive composition may improve bulk and softness of the tissue.

### CROSS-REFERENCE TO RELATED APPLICATION

This application is a continuation of U.S. patent application Ser. No. 12/979,852 filed Dec. 28, 2010. The entirety of application Ser. No. 12/979,852 is hereby incorporated by reference.

### BACKGROUND OF THE INVENTION

Absorbent nonwoven products such as paper towels, facial tissues, bath tissues and other similar products are designed to have desired levels of bulk, softness and strength. For example, in some tissue products, softness is enhanced by the topical addition of an additive composition (e.g. a softening agent) to the outer surface(s) of a tissue web.

The additive composition is a bonding agent that is topically applied to tissue substrates (or other nonwovens) alone or in combination with creping operations. For instance, creping may be part of a nonwoven manufacturing process wherein tissue is adhered to the hot surface of a rotating dryer drum by an additive composition. The dried tissue and additive composition are together scraped off the dryer via a doctor blade assembly. Creping adds bulk to tissue base sheets which in turn, increases softness as determined by hand feel. Other properties are affected as well, such as strength, flexibility, crepe folds and the like.

Typically, additive compositions are sprayed onto the dryer drum of a Yankee dryer. However, the spraying process has low chemical mass efficiency levels (40% to 70%) due to waste of the additive composition caused by a boundary layer of air near the dryer's surface and relatively high dryer temperatures. By necessity, the applicator is typically about 4 inches (101.6 mm) away from the dryer surface. Due to the high rotational speed of the dryer, the boundary layer of air near the dryer surface is pulled along creating a pressure barrier that inhibits spray particles from reaching the dryer surface.

Thus, a need exists for a method of applying an additive composition (e.g. a softening agent) to a dryer surface, so that the chemical mass efficiency is increased as compared to the prior art methods. Further, there is a need for a method of applying an additive composition to a substrate so that the substrate is at least as soft as the nonwoven materials that have instead had the additive chemistry sprayed onto a heated dryer drum.

### SUMMARY

The present invention is a method of creping a nonwoven substrate comprising the steps of: a) positioning an additive-composition applicator adjacent to a hot non-permeable dryer surface; b) applying a frothed dispersion or frothed solution comprising an additive composition to the dryer surface; c) allowing the frothed dispersion or frothed solution to convert to an adhesive film; d) directly bonding the nonwoven substrate to the adhesive film; and e) scraping the bonded nonwoven substrate and adhesive film from the dryer surface.

Other features and aspects of the present invention are discussed in greater detail below.

### BRIEF DESCRIPTION OF DRAWINGS

For the purpose of illustrating the invention, there is shown in the drawings a form that is exemplary; it being understood, however, that this invention is not limited to the precise arrangements and instrumentalities shown.

FIG. 1 is a schematic view of process steps used to create one embodiment of a froth according the present invention.

FIG. 2 is a side schematic view of the Yankee dryer of FIG. 1, showing the froth application to the dryer surface according to one embodiment of the present invention.

FIG. 3 is a side schematic view of an offline creping process according to one embodiment of the present invention, specifically showing froth application to the surface of a non-porous drum.

FIG. 4 is a schematic view of a tissue manufacturing process using creping equipment.

FIG. 5 is a schematic view of a tissue manufacturing process that does not include creping equipment.

FIG. 6 is a series of SEM photographs showing the structural change of a tissue material after being treated by one embodiment of a method of the present invention.

FIG. 7 is a side cross-section of a prior art parabolic chemical additive applicator.

FIG. 8 is a side cross section of one parabolic chemical additive applicator according to one embodiment of the present invention.

FIG. 9 is a front perspective view of the parabolic applicator shown in FIG. 8.

FIG. 10 is a front perspective view of the parabolic applicator of FIG. 9, modified to include wipes according to another embodiment of the present invention.

FIG. 11 is a partial side perspective view of the parabolic applicator of FIG. 10, modified to include end dams according to yet another embodiment of the present invention.

FIG. 12 is a front perspective view of the parabolic applicator of FIG. 9, modified to include rollers according to a further embodiment of the present invention.

FIG. 13 is a partial side elevation of the parabolic applicator of FIG. 12.

### DEFINITIONS

“Additive composition” as used herein refers to chemical additives (sometimes referred to as chemical, chemistry, chemical composition and add-on) that are applied topically to a substrate. Topical applications in accordance with the method of the present invention may occur during a drying process, or a converting process. Additive compositions according to the present invention may be applied to any substrate (e.g. tissues or nonwovens).

“Airlaid web” as used herein is made with an air forming process, wherein bundles of small fibers, having typical lengths ranging from about 3 to about 52 millimeters (mm), are separated and entrained in an air supply and then deposited onto a forming screen, usually with the assistance of a vacuum supply. The randomly deposited fibers are then bonded to one another using, for example, hot air or a spray adhesive. The production of airlaid nonwoven composites is well defined in the literature and documented in the art. Examples include, but are not limited to, the DanWeb process as described in U.S. Pat. No. 4,640,810 to Laursen et al. and assigned to Scan Web of North America Inc.; the Kroyer process as described in U.S. Pat. No. 4,494,278 to Kroyer et al.; and U.S. Pat. No. 5,527,171 to Soerensen assigned to Niro Separation a/s; and the method of U.S. Pat. No. 4,375,448 to Appel et al. assigned to Kimberly-Clark Corporation, or other similar methods.

“Bonded Carded Web” or “BCW” refers to a nonwoven web formed by carding processes as are known to those skilled in the art and further described, for example, in U.S. Pat. No. 4,488,928, which is incorporated herein by reference to the extent it is consistent to the present invention. In the carding process, one may use a blend of staple fibers, bonding fibers, and possibly other bonding components, such as an adhesive. These components are formed into a bulky ball that is combed or otherwise treated to create a substantially uniform basis weight. This web is heated or otherwise treated to activate any adhesive component, resulting in an integrated, lofty, nonwoven material.

“Coform” as used herein is a meltblown polymeric material to which fibers or other components may be added. In the most basic sense, coform may be made by having at least one meltblown die head arranged near a chute through which other materials are added to the meltblown materials as the web is formed. These “other materials” may be natural fibers, superabsorbent particles, natural polymer fibers (for example, rayon) and/or synthetic polymer fibers (for example, polypropylene or polyester). The fibers may be of staple length.

One exemplary process for producing coform webs involves the extrusion of a molten polymeric material through a die head to form fine streams, the streams are attenuated by converging flows of high velocity, heated gas (usually air) supplied from nozzles to break the polymer streams into discontinuous microfibers of a small diameter. The die head, for instance, can include at least one straight row of extrusion apertures. In general, the microfibers may have an average fiber diameter of up to about 10 microns. The average diameter of the microfibers can be generally greater than about 1 micron, such as from about 2 microns to about 5 microns. While the microfibers are predominantly discontinuous, they generally have a length exceeding the length normally associated with staple fibers. Other coform processes are shown in commonly assigned U.S. Pat. Nos. 4,818,464 to Lau and 4,100,324 to Anderson et al., which are incorporated herein by reference.

In order to combine the molten polymer fibers with another material such as pulp fibers, a primary gas stream is merged with a secondary gas stream containing individualized wood-pulp fibers. These pulp fibers become integrated with the polymer fibers in a single step. (The wood pulp fibers can have a length from about 0.5 millimeters to about 10 millimeters.) The integrated air stream is directed onto a forming surface to air-form the nonwoven fabric. The nonwoven fabric may be passed between of a pair of vacuum rolls to further integrate the two different materials.

Coform material may contain cellulosic material in an amount from about 10% by weight to about 80% by weight, such as from about 30% by weight to about 70% by weight. For example, in one embodiment, a coform material may be produced containing pulp fibers in an amount from about 40% by weight to about 60% by weight.

“Creping” as defined herein occurs when a polymer that is adhered to a web is scraped off of a dryer surface (e.g. a Yankee dryer surface) with a doctor blade. For example, as will be explained in more detail herein, a frothed composition is applied to a heated dryer that evaporates water from the frothed composition. The heat of the dryer changes the frothed composition into a polymer film. Using compression force, the web contacts the film on the surface of the dryer so that it adheres thereto prior to being creped.

“Froth” as defined herein is a liquid foam. According to the present invention, when the frothable composition of the present invention is heated, it will not form a solid foam structure. Instead, when applied to a heated surface, the frothable composition turns into a substantially continuous film.

“Hydroentangled web” according to the present invention refers to a web that has been subjected to columnar jets of a fluid causing the web fibers to entangle. Hydroentangling a web typically increases the strength of the web. In one aspect, pulp fibers can be hydroentangled into a continuous filament material, such as a “spunbond web.” The hydroentangled web resulting in a nonwoven composite may contain pulp fibers in an amount from about 50% to about 80% by weight, such as in an amount of about 70% by weight. Hydroentangled composite webs as described above are commercially available from the Kimberly-Clark Corporation under the name HYDROKNIT. Hydraulic entangling is described in, for example, U.S. Pat. No. 5,389,202 to Everhart, which is incorporated herein by reference.

“Nonwoven” is defined herein as a class of fabrics generally produced by attaching fibers together. Nonwoven fabric is made by mechanical, chemical, thermal, adhesive, or solvent means, or any combination of these. Nonwoven manufacture is distinct from weaving, knitting, or tufting. Nonwoven fabrics may be made from synthetic thermoplastic polymers or natural polymers such as cellulose. Cellulosic tissue is one example of a nonwoven material.

“Meltblowing” as used herein is a nonwoven web forming process that extrudes and draws molten polymer resins with heated, high velocity air to form fine filaments. The filaments are cooled and collected as a web onto a moving screen. The process is similar to the spunbond process, but meltblown fibers are much finer and generally measured in microns.

“Spunbond” as used herein is a nonwoven web process in which the filaments have been extruded, drawn and laid on a moving screen to form a web. The term “spunbond” is often interchanged with “spunlaid,” but the industry has conventionally adopted the spunbond or spunbonded terms to denote a specific web forming process. This is to differentiate this web forming process from the other two forms of the spunlaid web forming, which are meltblowing and flashspinning.

“Spunbond/Meltblown composite” as used herein is a laminar composite defined by a multiple-layer fabric that is generally made of various alternating layers of spunbond (“S”) webs and meltblown (“M”) webs: SMS, SMMS, SSMMS, etc.

“Tissue” as used herein generally refers to various paper products, such as facial tissue, bath tissue, paper towels, table napkins, sanitary napkins, and the like. A tissue product of the present invention can generally be produced from a cellulosic web having one or multiple layers. For example, in one embodiment, the cellulosic or “paper” product can contain a single-layered paper web formed from a blend of fibers. In another embodiment, the paper product can contain a multi-layered paper (i.e., stratified) web. Furthermore, the paper product can also be a single- or multi-ply product (e.g., more than one paper web), wherein one or more of the plies may contain a paper web formed according to the present invention.

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

It is to be understood by one of ordinary skill in the art that the present discussion is a description of exemplary embodiments only, and is not intended as limiting the broader aspects of the present disclosure.

### DETAILED DESCRIPTION

The present invention is an alternative to the current method of spraying onto a dryer surface (e.g. the drum of a Yankee dryer) an aqueous dispersion of creping chemicals. In contrast to liquid chemistry, the frothed chemistry has enough structural integrity to reach the dryer surface. By creating a frothed chemistry according to the present invention, a chemistry applicator can be placed in much closer proximity to the dryer surface.

One advantage of the present invention is that less energy is consumed by the dryer. The close proximity of the chemistry applicator to the dryer surface improves chemical mass efficiency (i.e., decrease waste in application process) and energy efficiency. Efficiency is increased because the air introduced into the froth of the present invention acts as a diluter. As a result, less heat is required to remove water from the creping chemistry (additive composition) during the drying process. This is an improvement over the spraying process which uses water to dilute the additive composition.

An additional advantage of the process of the present invention is that after the creping step, the dry layer of additive composition remaining on the tissue substrate surface adds more bulk. This increase in bulk is due to the entrapped air inside the coated layer. Though the frothed additive composition becomes a film during the drying step, not all of the air entrapped in the froth is lost during the drying step due to the higher viscosity associated with higher solid-levels in the frothed additive composition.

Various substrates other than tissue may be treated in accordance with the present disclosure. Examples include, but are not limited to, wet-laid webs, airlaid webs, spunbond webs, coform webs, and hydroentangled webs. The additive composition is typically applied on one side of any substrate, but could be applied to both sides as desired.

Foaming Agents:

Most commercial foaming agents are suitable for creating the froth of the present invention. Suitable foaming agents include polymeric materials in liquid form. These foaming agents can be divided into four groups depending on function:
(1) Air Entrapment Agent—used to enhance a liquid's (dispersion, solution, etc.) capability to entrap air which can be measured by determining a “blow ratio.” An exemplary list of foaming agents include but is not limited to potassium laurate, sodium lauryl sulfate, ammonium lauryl sulfate, ammonium stearate, potassium oleate, disodium octadecyl sulfosuccinimate, hydroxypropyl cellulose, etc. Stabilization Agent—used to enhance stability of froth's air bubbles against time and temperature; examples include, but are not limited to, sodium lauryl sulfate, ammonium stearate, hydroxypropyl cellulose, etc.
(2) Wetting Agent—used to enhance the wettability of a film-coated dried surface. Examples include, but are not limited to, sodium lauryl sulfate, potassium laurate, disodium octadecyl sulfosuccinimate, etc.
(3) Gelling Agent—used to stabilize air bubbles in the froth by causing the additive composition to take the form of a gel which serves to reinforce cell walls. Examples include, but are not limited to, hydroxypropyl cellulose, hydroxyethyl cellulose, carboxymethyl cellulose and other modified cellulose ethers.

Some foaming agents can deliver more than one of the functions listed above. Therefore, it is not necessary to use all four foaming agents in a frothable additive composition.

Frothable compositions of water insoluble polymers may be in the form of dispersions. The water insoluble polymer materials that are solids, such as powder, granules, etc., need to be converted into a frothable dispersion by mixing it with water, and air and foaming agent(s) under certain processing conditions such as high pressure extrusion at an elevated temperature.

Frothable compositions of water soluble polymers may also be in the form of solutions. The water-soluble polymer materials that are solids, such as powder, granules, etc, need to be dissolved into a solution. Then, in most of cases, the solution is mixed with air and a package of foaming agents to convert it into a froth.

Examples of dispersions according to the present invention include, but are not limited to, a polyolefin dispersion such as HYPOD 8510, commercially available from Dow Chemical, Freeport, Tex., U.S.A.; and a polyisoprene dispersion, such as KRATON, commercially available from Kraton Polymers U.S. LLC, Houston, Tex., U.S.A. polybutadiene-styrene block copolymer dispersion, latex dispersion such as E-PLUS, commercially available from Wacker, Munich, Germany; polyvinyl pyrrolidone-styrene copolymer dispersion and polyvinyl alcohol-ethylene copolymer dispersion, both are available from Aldrich, Milwaukee, Wis., U.S.A.

Examples of solutions according to the present invention include both synthetic and natural based water soluble polymers. The synthetic water soluble polymers include, but are not limited to, polyalcohols, polyamines, polyimines, polyamides, polycarboxlic acids, polyoxides, polyglycols, polyethers, polyesters, copolymers and mixtures of the listed above.

The natural based water soluble polymers include, but are not limited to, modified cellulose, such as cellulose ethers and esters, modified starch, chitosan and its salts, carrageenan, agar, gellan gum, guar gum, other modified polysaccharides and proteins, mixture of the above. In one particular embodiment, the water-soluble film forming components also include: poly(acrylic acid) and salts thereof; poly(acrylate esters); and poly(acrylic acid) copolymers. Other suitable water-soluble film forming components include polysaccharides of sufficient chain length to form films such as, but not limited to, pullulan and pectin. For example, the water soluble film-forming polymer may contain additional monoethylenically unsaturated monomers that do not bear a pendant acid group, but are copolymerizable with monomers bearing acid groups. Such compounds include, for example, the monoacrylic esters and monomethacrylic esters of polyethylene glycol or polypropylene glycol, the molar masses (Mn) of the polyalkylene glycols being up to about 2,000, for example.

In another particular embodiment, the water-soluble film forming component is hydroxypropyl cellulose (HPC) sold by Ashland, Inc. under the brand name of KLUCEL. The water-soluble film forming component can be present in the add-on in any operative amount and will vary based on the chemical component selected, as well as on the end properties that are desired. For example, in the exemplary case of KLUCEL, the biodegradable, water-soluble modifier component can be present in the add-on in an amount of about 1-70 wt %, or at least about 1 wt %, such as at least about 5 wt %, or least about 10 wt %, or up to about 30 wt %, such as up to about 50 wt % or up to about 75 wt % or more, based on the total weight of the add-on, to provide improved benefits. Other examples of suitable first water-soluble biodegradable film forming components include methyl cellulose (MC) sold by Ashland, Inc. under the brand name “BENECEL”; hydroxyethyl cellulose sold by Ashland, Inc. under the brand name “NATROSOL”; and hydroxypropyl starch sold by Chemstar (Minneapolis, Minn., U.S.A.) under the brand name “GLUCOSOL 800.” Any of these chemistries, once diluted in water, are disposed onto a non-porous dryer surface to ultimately transfer the chemistry to the web surface. The water soluble polymers in these chemistries include polyvinyl alcohol, polyethylene glycol, polyethylene oxide, hydroxypropyl starch, and hydroxypropyl cellulose.

“Conventional” creping chemistries for tissue manufacturing may include an adhesive which comprises an aqueous admixture of polyvinyl alcohol (PVOH) and a water-soluble, thermosetting, cationic polyamide-epihalohydrin resin, (see Soerens U.S. Pat. No. 4,501,640, included by reference to the extent it does not conflict with the present invention). The polyvinyl alcohol can be, for instance, CELVOL 523, available from Celanese Corporation (Dallas, Tex., U.S.A.). The polyamide-epihalohydrin resin can be KYMENE 557-H, available from Ashland Corporation (Covington, Ky., U.S.A.). Additional variations of conventional creping chemistries also include REZOSOL 1095, available from Ashland Corporation (Covington, Ky., U.S.A.). The ratio of chemicals included in the conventional creping mixtures is varied over a large range. However, a typical mixture may be 40% PVOH, 40% KYMENE 557-H, and 20% REZOSOL 1095.

In a desired application, the additive composition level is about 50 to 10,000 mg/m², or about 50 to 1000 mg/m² or about 100 to 600 mg/m². The difference between these suggested ranges is dependent on whether or not the additive composition is applied to a substrate either in-line (such as a tissue machine), or an off-line machine (such as a non-woven converting line).

Also, in the prior art, additive composition dispersion consists of water, a polyethylene-octene copolymer, and a copolymer of ethylene and acrylic acid. The polyethylene-octene copolymer may be obtained commercially from the Dow Chemical Corporation under the name “AFFINITY” (type 29801) and the copolymer of ethylene and acrylic acid may be obtained commercially from the Dow Chemical Corporation under the name “PRIMACOR” (type 59081). PRIMACOR acts as a surfactant to emulsify and stabilize AFFINITY dispersion particles. HYPOD” type 8510 is an ethylene copolymer with a high carboxyl content and is available commercially from the Dow Chemical Corporation.

The acrylic acid co-monomer is neutralized by potassium hydroxide to a degree of neutralization of around 80%. Therefore, in comparison, PRIMACOR is more hydrophilic than is AFFINITY. In a dispersion, PRIMACOR acts as a surfactant or a dispersant. Unlike PRIMACOR, AFFINITY, as suspended in a dispersion, takes on a form of tiny droplets with a diameter of a few microns. PRIMACOR molecules surround the AFFINITY droplets to form a “micelle” structure that stabilizes the droplets.

When the dispersion becomes a molten liquid on the dryer's hot surface, AFFINITY forms a continuous phase and PRIMACOR a dispersing phase forming islands in the AFFINITY “ocean.” This phase change is called phase inversion. However, occurrence of this phase inversion depends upon external conditions such as temperature, time, molecular weight of solids, and concentration. Ultimately, phase inversion only occurs when the two polymers (or two phases) have enough relaxation time to allow phase inversion completion. In the present invention, HYPOD coated film retains a dispersion morphology which indicates there is an incompletion of phase inversion. Benefits of the remaining dispersion morphology include, but are not limited to, a more hydrophilic coating layer due to the exposure of the PRIMACOR phase; and more improved softness of the coated product due to entrapped air bubbles inside the coated HYPOD layer which provide extra bulkiness.

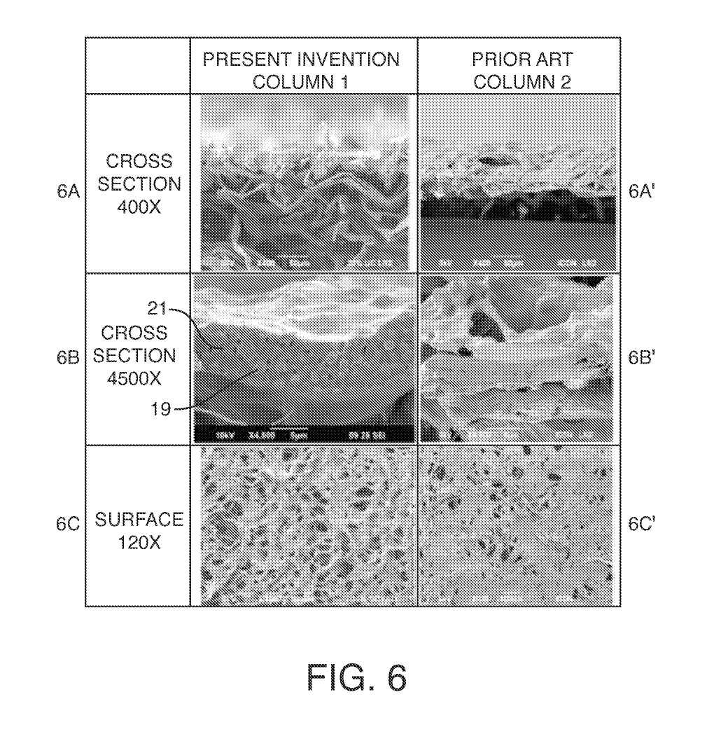

The diluted dispersion may have a very low viscosity (around 1 cp, just like water). A low viscosity dispersion, when applied onto a hot Yankee dryer drum, will undergo a process of water evaporation and a complete phase inversion of AFFINITY. The resulting continuous molten film then has PRIMACOR dispersion islands embedded therein. The film formed after completely evaporating the water is solid without any air bubbles entrapped therein. After transferring the molten film onto a the web through the creping process, the thin film covering the surface of the treated tissue is discontinuous yet interconnected, see FIG. 6c, discussed infra.

The new process of the present invention is quite different from the prior art process. The new process may use a high solid, high viscosity dispersion of (10 to 30 wt. %) and may contain a large amount of air bubbles (air volume is at least 10 times more than the dispersion volume). Desirably, the commercially available HYPOD dispersion (42% solids) has a viscosity around 500 cps whereas water has a viscosity around 1 cps. A dispersion containing about 20% HYPOD may have a viscosity around 200 cps, a relatively high viscosity, while a dispersion having less than 1% HYPOD may have a viscosity close to water's viscosity (1 cp). After entrapping a high ratio of air, the viscosity of the frothed HYPOD dispersion has been increased exponentially.

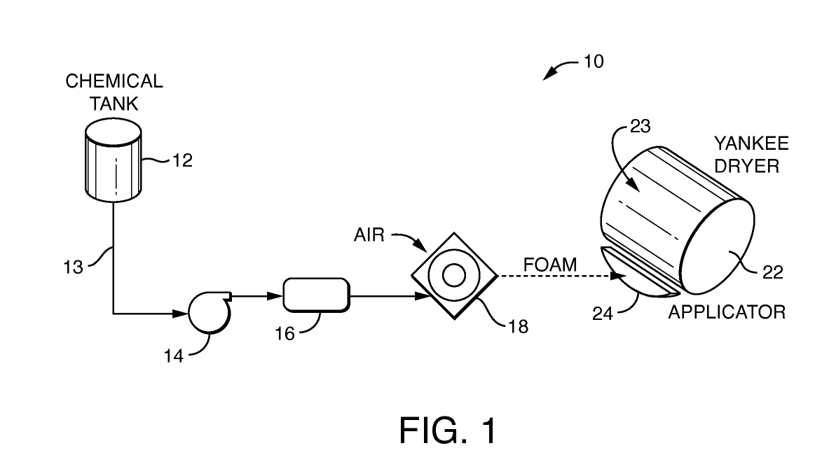

Referring to FIG. 1, when a frothed dispersion is applied onto the non-porous dryer surface 23, a limited amount of water will be quickly evaporated therefrom. It is thought that the dispersion's slow evaporation due to high solids combined with its high viscosity will prevent the AFFINITY-PRIMACOR dispersion from completing the phase inversion and entrapped air from escaping. This results in a unique micro-structured molten film on the Yankee dryer surface.

Referring to FIG. 6, the SEM photos confirm this hypothesis. Two immediate benefits can be observed when comparing the prior art surface-treated tissues and the surface-treated tissues of the present invention. First, the method of the present invention yields a tissue that is more bulky and has a softer hand feel due to entrapment of air bubbles 21 (see FIG. 6b). Second, the tissue of the present invention has a more wettable surface due to incomplete phase inversion, which in turn results in surface exposure of the hydrophilic component.

Visually compare FIGS. 6a, 6b, 6c to FIGS. 6a′, 6b′, 6c′. The coated layer having dispersion beads 19 and entrapped air bubbles 21 shown in FIG. 6b, is softer than the melted film shown in FIG. 6b′ as determined by the In Hand Ranking Test disclosed herein.

Froth Generating Process: In general, preparing frothed chemicals utilizes a system that pumps both liquid and air into a mixer. The mixer blends the air into the liquid to produce a froth which inherently includes a plurality of small air bubbles. The froth exits the mixer and flows to an applicator.

One parameter to define the quality of frothed chemistry is the blow ratio, which is defined by ratio of volume of small air bubbles entrapped by dispersion chemical to the volume of the dispersion before mixing. For example, at a blow ratio of 10:1, a dispersion flow rate of 1 liter/minute will be able to entrap 10 liters/minute of air into its liquid and produce a total froth flow rate of 11 liters per minute.

To achieve a high blow ratio, both the mechanical mixing and the frothing capability of the additive composition are determining factors. If a chemical can only hold or entrap air volume up to a blow ratio of 5, no matter how powerful a froth unit is, it won't be able to produce a stable froth having a blow ratio of 10. Any extra air beyond the blow ratio of 5 will release out of the froth system once the mechanical force is removed. In other words, any entrapped air higher than the dispersion's air containment capability will become instable. Most of such instable air bubbles will escape from the froth (debubbling) immediately after mechanical agitation is stopped.

Referring to FIG. 1, shown schematically is a system 10 that can generate the frothed chemistry according to the present invention. To begin, frothable chemicals (e.g. HYPOD, KRATON, etc.) are placed in a chemical tank 12. The chemical tank 12 is connected to a pump 14. It may be desirable to modify piping 13 between the chemical tank 12 and pump 14 so that one may transmit the frothable chemicals to two different sizes of pumps. Desirably the chemical tank 12 is situated at an elevated level above the pump 14 in order to keep the pump primed.

One optional small secondary pump (not shown) may be used for running the frothing process at slow speeds relative to pump 14. The larger primary pump 14 is capable of producing flow rates up to 25 liters/minute liquid flow-rate for high application speeds and/or high amounts of additive composition. The smaller, secondary pump is capable of liquid flow rates up to 500 cc/min. and/or low additive composition.

A flow meter 16 is situated between the pump(s) 14 and a foam mixer 18. Liquid flow rates are calculated from desired additive composition, chemical solids, line-speed and applicator width. The flow rate may range from about 5:1 to 50:1. When using the small secondary pump, its flow rate ranges from 10 to 500 cc/min. When using the large pump 14, its flow rate ranges from 0.5 to 25 liter/min. A 20 liter/minute air flow meter is selected when using the small secondary pump. There is a 200 liter/minute air flow meter to use when running the larger primary pump 14.

In one aspect, the foam mixer 18 is used to blend air into the liquid mixture of frothable chemicals to create small air bubbles in the froth. Air is metered into the system 10 using certain liquid flow rates and blow ratios as discussed above. Desirably, the foam mixer 18 having a size of 25.4 cm (10 inches) may be used to generate froth. One possible foam mixer 18 is a CFS-10 inch Foam Generator from Gaston Systems, Inc. of Stanley, N.C., U.S.A.

Desirably, the rotational speed of the foam mixer 18 is limited to about 600 rpm. The rpm speed for the mixer in this process is dependent upon the additive composition's ability to foam (i.e., its capability of entrapping air to form stable bubbles). If the additive composition foams easily, a lower rpm is generally required. If the additive composition does not foam easily, a higher rpm is generally required. The higher mixer speed helps to speed up the foam equilibrium or optimal blow ratio. A normal rpm for the mixer is about 20%-60% of the maximum rpm speed. The type of and/or amount of foam agent in addition to the additive composition also has an effect on the mixer speed requirement.

The froth is checked for bubble uniformity, stability and flow pattern. If bubble uniformity, stability and flow pattern are not to desired standards, adjustments may be made to flow rates, mixing speeds, blow ratio, and/or chemical compositions of the solutions/dispersions before directing the froth to the applicator 24.

In one aspect of the invention, HYPOD, or other chemistries to be frothed and used for the creping package are blended and added to the chemical tank 12. Dilute solutions of HYPOD (<10% total solids) and other hard-to-froth chemistries generally require something added to the formulation to increase viscosity and foamability. For example, hydroxypropyl cellulose or other foaming agents or surfactants, can be used to produce a stable froth for uniform application onto the heated and non-permeable surface of a rotating drum of a Yankee Dryer.

Substrate Materials: Suitable substrate materials include but are not limited to facial tissue; uncreped through air-dried tissue (UCTAD); paper toweling; HYDROKNIT nonwoven material from Kimberly Clark Corporation, Neenah, Wis., U.S.A.; spunbond; coform; bonded carded web (“BCW”); airlaid, film/laminate sheet, and all types of paper, tissue and other nonwoven products.

In the non-limiting examples discussed herein, the frothed chemistry may be applied to a tissue. As used herein, tissue products are meant to include facial tissue, bath tissue, paper towels, diaper or feminine care liners and outer covers, napkins and the like. Tissue may be made in different ways, including but not limited to conventionally felt-pressed tissue paper; high bulk pattern densified tissue paper; and high bulk, uncompacted tissue paper. Tissue paper products made therefrom can be of a single-ply or multi-ply construction. See US Patent Publication No. 2008/0135195, incorporated herein to the extent that it is consistent with the present invention.

Desirably, tissue paper used with the process of the present invention has a basis weight of between about 10 g/m2 and about 65 g/m2, and a density of about 0.6 g/cc or less. More desirably, the basis weight will be about 40 g/m2 or less and the density will be about 0.3 g/cc or less. Most desirably, the density will be between about 0.04 g/cc and about 0.2 g/cc. Unless otherwise specified, all amounts and weights relative to the paper are on a dry basis.

Desirably, in one aspect of the invention, tissue tensile strength in the machine direction may be in the range of from about 100 to about 5,000 grams per inch of width. Tensile strength in the cross-machine direction may be in the range of from about 50 grams to about 2,500 grams per inch of width.

Desirably, in one aspect of the present invention, tissue absorbency is typically about 5 grams of water per gram of fiber to about 9 grams of water per gram of fiber.

In a typical papermaking process, a low consistency pulp furnish is provided from a pressurized headbox, which has an opening for delivering a thin deposit of pulp furnish onto the forming fabric or Fourdrinier wire to form a wet web. The web is then typically dewatered by vacuum dewatering to a fiber consistency of between about 7% and about 25% (total web basis weight).

The dewatered web may be pressed and dried by a steam drum apparatus known in the art as a Yankee dryer. Pressure can be developed at the Yankee dryer by mechanical means such as an opposing cylindrical drum pressing against the web. This is referred to as a pressure roll.

Multiple Yankee dryer drums may also be employed, whereby additional pressing is optionally incurred between the drums. The formed sheets are considered to be compacted since the entire web is subjected to substantial mechanical compression forces while the fibers are moist. The web is dried while in this compressed state.

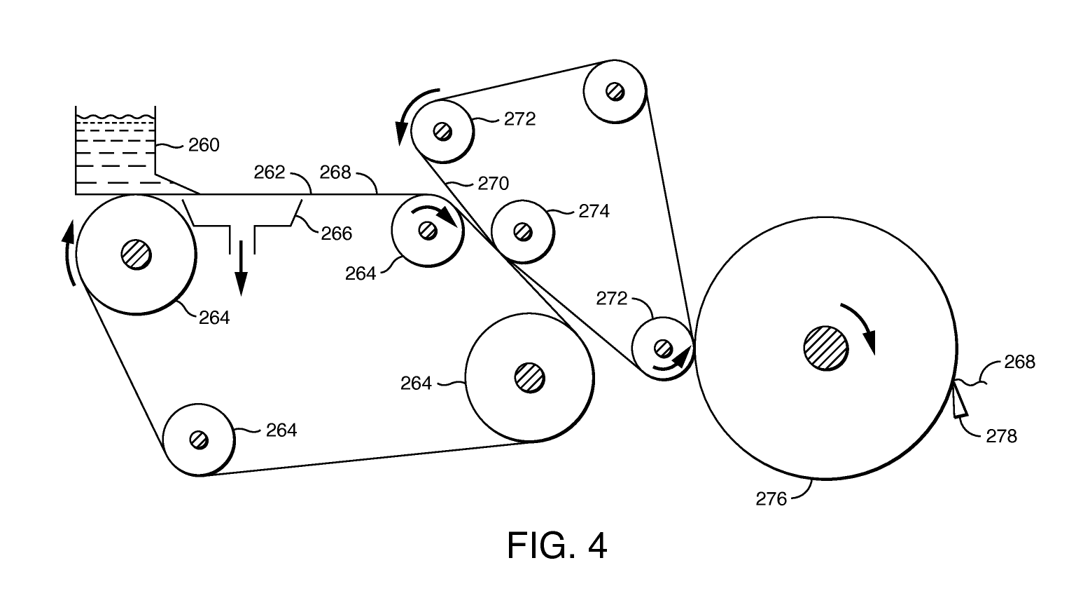

Shown in FIG. 4 is one embodiment of a process for forming wet creped tissue webs. First, a headbox 260 emits an aqueous suspension of fibers onto a forming fabric 262 which is supported and driven by a plurality of guide rolls 264. A vacuum box 266 is disposed beneath the forming fabric 262 and is adapted to remove water from the fiber furnish to assist in forming a web. From forming fabric 262, a formed web 268 is transferred to a second fabric 270, which may be either a wire or a felt. Fabric 270 is supported for movement around a continuous path by a plurality of guide rolls 272. Also included is a pick up roll 274 designed to facilitate transfer of web 268 from fabric 262 to fabric 270.

From fabric 270, web 268, in this embodiment, is transferred to the surface of a rotatable heated dryer drum 276, such as a Yankee dryer.

In accordance with one embodiment of the present disclosure, the additive composition may be applied to the surface of the dryer drum 276 for transfer onto one side of the tissue web 268. In this manner, the additive composition adheres the tissue web 268 to the dryer drum 276. In this embodiment, as web 268 is carried through a portion of the rotational path of the dryer surface, heat is imparted to the web causing most of the moisture contained within the web to be evaporated. Web 268 is then removed from dryer drum 276 by a creping blade 278. Creping the web 268 as it is formed further reduces internal bonding within the web and increases softness.

Another embodiment for forming a tissue of the present invention will now be described. Specifically, this embodiment relates to one method for forming the tissue of the present invention with elevated elements utilizing a papermaking technique known as uncreped through-air dried (“UCTAD”). Examples of such a technique are disclosed in U.S. Pat. No. 5,048,589 to Cook, et al.; U.S. Pat. No. 5,399,412 to Sudall, et al.; U.S. Pat. No. 5,510,001 to Hermans, et al.; U.S. Pat. No. 5,591,309 to Rugowski, et al.; and U.S. Pat. No. 6,017,417 to Wendt, et al., which are incorporated herein in their entirety by reference thereto, to the extent it is consistent with the present invention.

The UCTAD process generally involves the steps of: (1) forming a furnish of cellulosic fibers, water, and optionally, other additives; (2) depositing the furnish on a traveling foraminous belt, thereby forming a fibrous web on top of the traveling foraminous belt; (3) subjecting the fibrous web to through-drying to remove the water from the fibrous web; and (4) removing the dried fibrous web from the traveling foraminous belt.

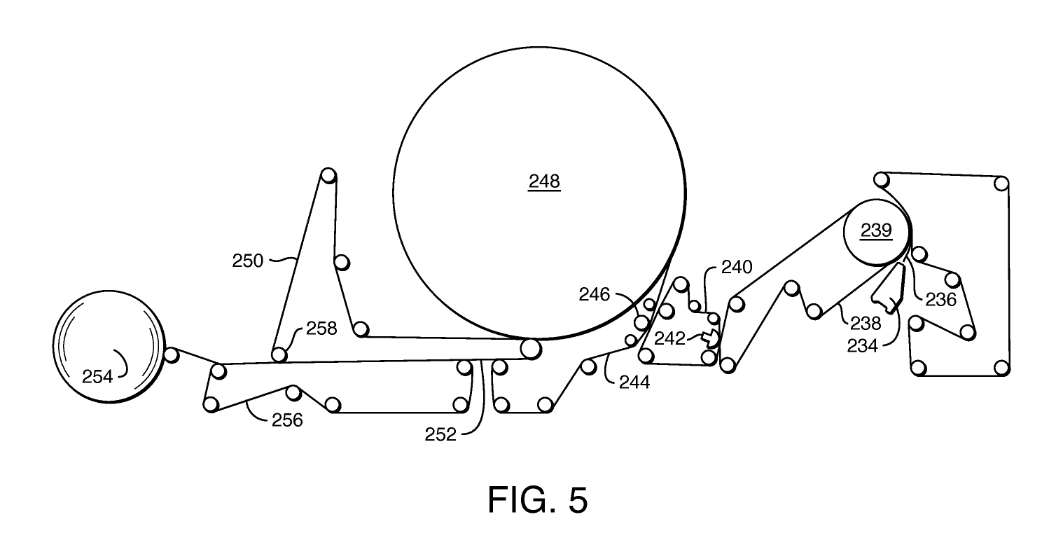

Referring now to FIG. 5, shown is one method for making UCTAD tissue sheets. (For simplicity, the various tensioning rolls schematically used to define the several fabric runs are shown, but not numbered. It will be appreciated that variations from the apparatus and method illustrated in FIG. 5 can be made without departing from the general process). Shown is a twin wire former having a papermaking headbox 234, such as a layered headbox, which injects or deposits a stream 236 of an aqueous suspension of papermaking fibers onto the forming fabric 238 positioned on a forming roll 239. The forming fabric serves to support and carry the newly-formed wet web downstream in the process as the web is partially dewatered to a consistency of about 10 dry weight percent. Additional dewatering of the wet web can be carried out, such as by vacuum suction, while the wet web is supported by the forming fabric. The wet web is then transferred from the forming fabric to a transfer fabric 240.

Transfer is preferably carried out with the assistance of a vacuum shoe 242 such that the forming fabric and the transfer fabric simultaneously converge and diverge at the leading edge of the vacuum slot. The web is then transferred from the transfer fabric to the through-drying fabric 244 with the aid of a vacuum transfer roll 246 or a vacuum transfer shoe.

The level of vacuum used for the web transfers can be from about 3 to about 15 inches of mercury (75 to about 380 millimeters of mercury), preferably about 5 inches (125 millimeters) of mercury. The vacuum shoe (negative pressure) can be supplemented or replaced by the use of positive pressure from the opposite side of the web to blow the web onto the next fabric in addition to or as a replacement for sucking it onto the next fabric with vacuum. Also, a vacuum roll or rolls can be used to replace the vacuum shoe(s).

While supported by the throughdrying fabric, the web is finally dried to a consistency of about 94 percent or greater by the throughdryer 248 and thereafter transferred to a carrier fabric 250. The dried basesheet 252 is transported to the reel 254 using carrier fabric 250 and an optional carrier fabric 256. An optional pressurized turning roll 258 can be used to facilitate transfer of the web from carrier fabric 250 to fabric 256.

Surface Coating Process: Unlike a process that sprays a dilute dispersion or solution onto Yankee dryer surface 23, the process of the present invention can apply high-solid frothed chemistry onto the surface 23.

In the prior art, the chemistry (e.g. HYPOD) dispersion is diluted to less than 1 wt % solid in water. By contrast, in the present invention, air is used to dilute a dispersion having up to 65 wt % of solids, or up to 20% solids, depending on the content of PRIMACOR described supra.

The high-solid coating process of the present invention exhibits four product and process benefits: (1) softer surface due to the unique micro-structure of the coated layer (see, FIG. 6); (2) less chemical waste due to close and direct application of the frothed chemistry; and (3) no need to use soft or deionized water due to the high ratio of chemistry to water (for example, a chemical such as HYPOD becomes instable when it is exposed to a large quantity of hard water, i.e., a solid level of 1% or less); and (4) less drying energy required to dry the frothed chemistry as well as the base sheet.

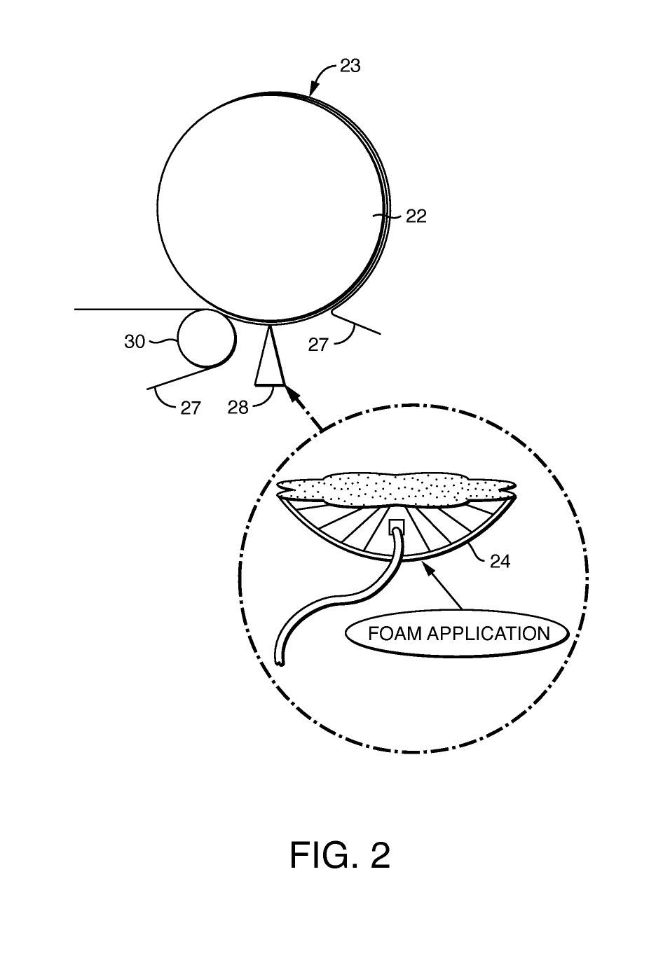

The frothed chemicals may be applied onto a substrate 27 by two ways: an inline application or an offline application. In the inline processes a foam generator and an applicator depicted in FIGS. 1 and 2, will be incorporated into a tissue manufacturing line as shown in FIG. 4 and the frothed chemicals will be applied onto any substrate 27 during the manufacture of same.

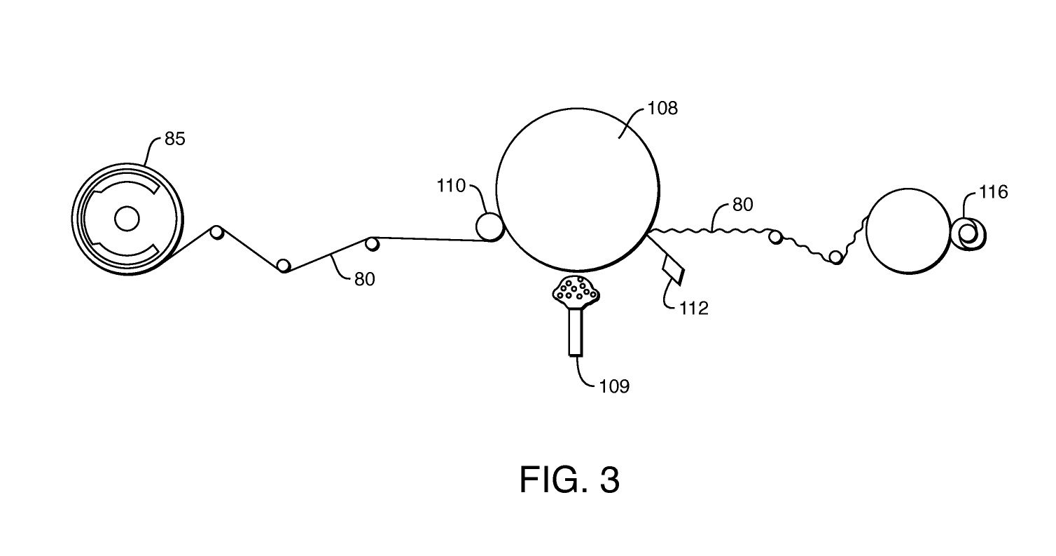

Referring to FIG. 3, the offline application enables application of the froth chemistry to those substrates 80 which are produced by a non-creping process. For example, uncreped through air dried (“UCTAD”) bath tissue and melt-spun nonwoven materials are suitable for use with the offline application method.

Referring to FIG. 1, in one aspect of the invention, the frothed chemicals are applied to the dryer surface 23 via an applicator 24. The froth applicator 24 is placed close to the dryer surface (0.64 cm or ¼ inch) for uniform froth distribution onto the dryer surface 23. Modifications to a prior art applicator 24 (described herein) are desired to better ensure direct contact of the frothed chemistry to the dryer surface 23, especially during high speed operations.

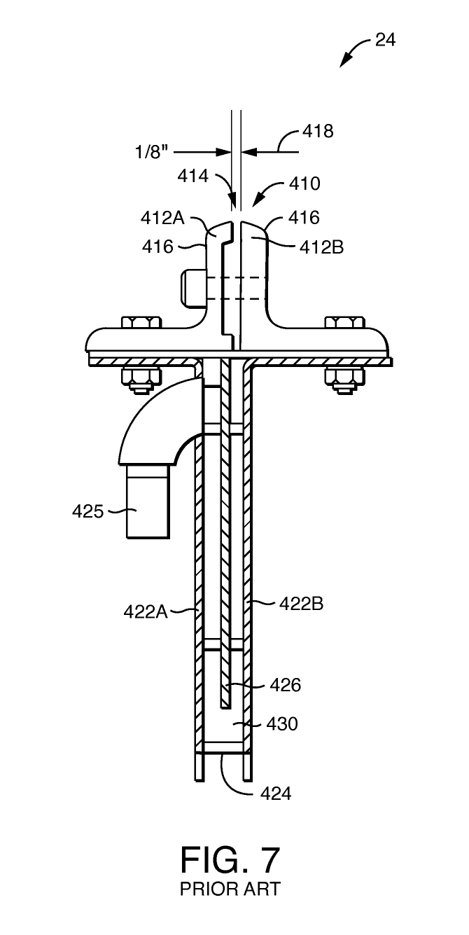

Referring to FIGS. 2 and 7, it is most desirable to use a single parabolic applicator 24 to apply chemistry to a rotating dryer drum surface 23. However, if varying levels of chemical application are required across the width of the dryer surface due to dryer or basesheet variability, applicators (not shown) with multiple zones of miniature parabolic applicators may be used.

Referring to FIG. 7, shown is a cross-section of the parabolic applicator available from Gaston Systems, Inc., located in Stanley, N.C., U.S.A. Preferably, this parabolic applicator 24 is having the same applicator lip length as the width of the substrate. Generally, the parabolic applicator 24 has an applicator lip 410 constructed in part by two pieces of steel angle, 412 A and 412B. These two pieces of steel angle define a slot opening 414 through which frothed chemicals can flow. As obtained from the manufacturer, the width 418 of slot opening 414 is 3.2 mm (⅛ inch), and the edges 416 of the steel angle applicator lip 410 are rounded to eliminate sharp edges.

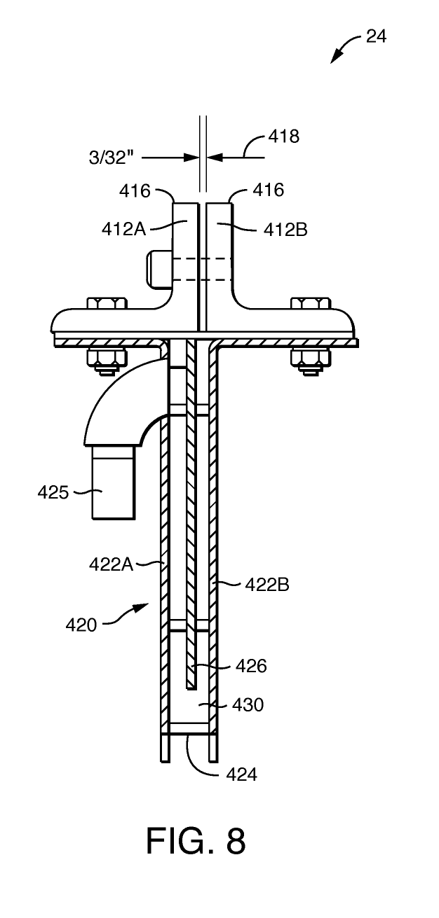

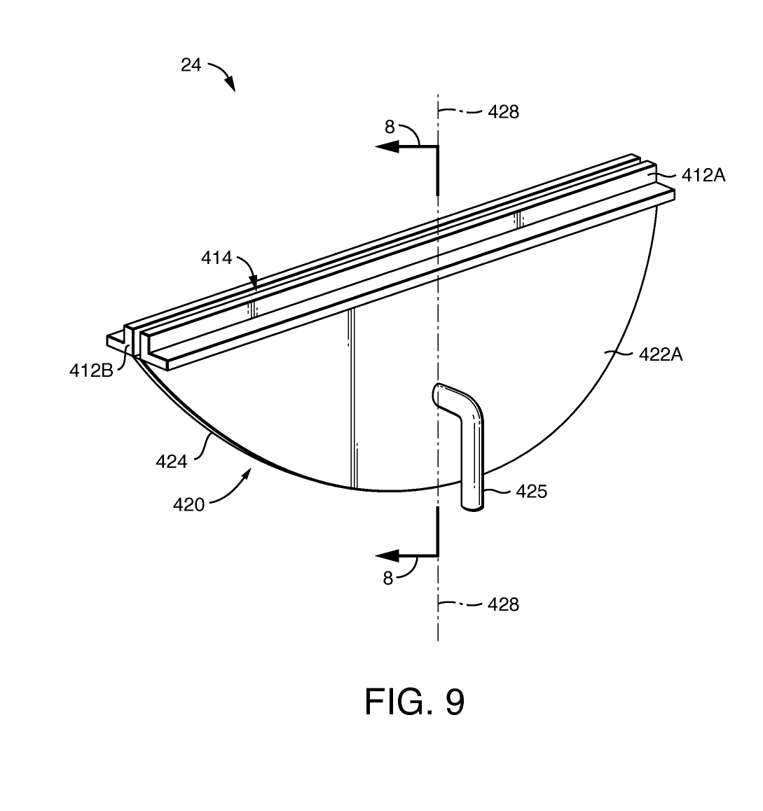

Referring to FIGS. 8 and 9, the prior-art parabolic applicator has been modified for the application of a frothed additive chemical to a dryer drum surface 23. Generally, the slot width 418 has been narrowed from 3.2 mm (⅛) inch to about 2.4 mm ( 3/32 inch). The narrower slot width 418 increases the foam velocity toward the intended surface (e.g. surface 23 of FIG. 1). Further, the edges 416 of the steel angle applicator lip 410 are squared, not rounded. The squared edges 416 increase the surface area of the applicator lip 410 which in turn increases the residence time the frothed chemicals have on the applicator lip 410. By increasing the residence time, the frothed chemistry has a greater tendency to attach to the dryer surface 23 as opposed to sliding down the applicator lip 410.

The complete applicator is shown in FIGS. 8 and 9. The applicator 24 includes a parabolic body 420. From the exterior, one can see that body 420 is constructed from two plates 422A and 422B which are joined to and separated by a side member 424. In addition, there is an inlet hose 425 desirably placed on along the symmetrical axis 428 of plate 422 A. The inlet hose 425 may be adjacent to the steel angle 412A as seen in FIG. 8, or lower as seen in FIG. 9.

FIG. 8 shows that inside body 420 is a distribution plate 426. The purpose of the distribution plate 426 is to disperse the fluid entering the applicator 24 through inlet hose 25. The distribution plate has the same general shape as the plates 422, yet is smaller in size so that there remains a gap 430 between the distribution plate 426 and the side 424. Desirably the distribution plate 426 is equidistant from each of the plates 422A and 422B. Between the plate 422B and distribution plate 426 is a gap from which fluid can flow to the slot opening 414. Desirably, slot opening 414 is located symmetrically between the plate 422B and the distribution plate 426.

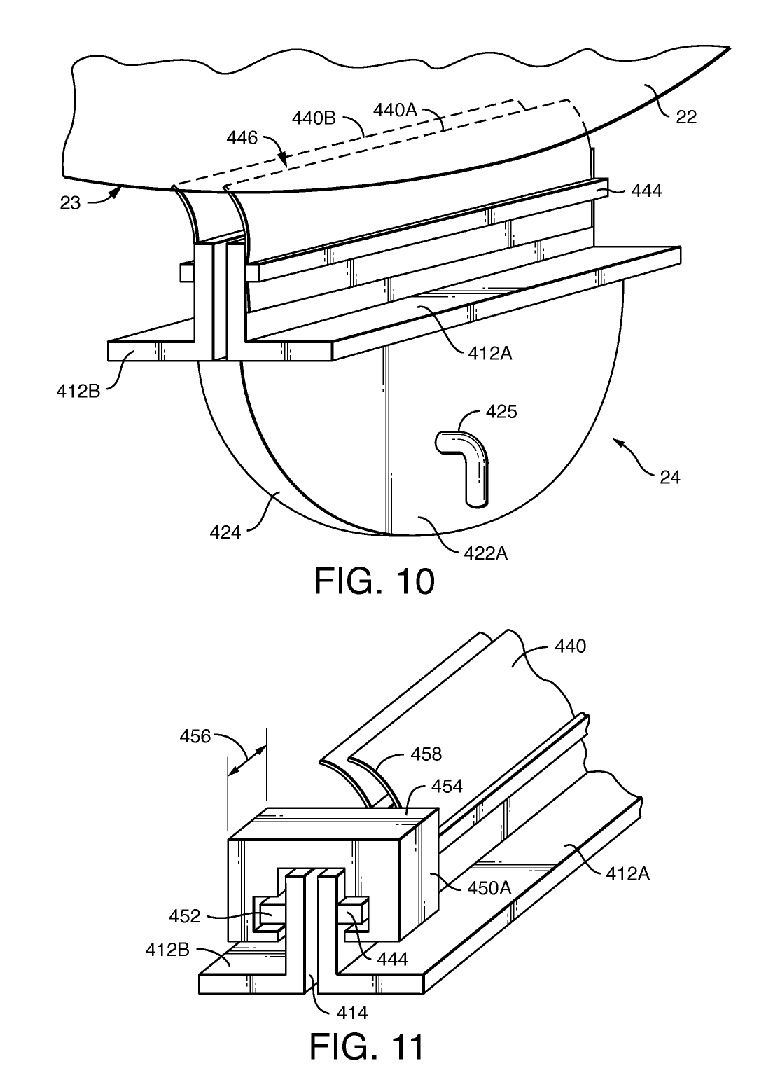

Referring to FIG. 10, in yet another embodiment, the purpose of felt wipes 440A and 440B (collectively referred to as felt wipes 440) is to spread a substantially uniform thickness of frothed additive composition on the dryer surface 23. This spreading action will result in a film of substantially uniform thickness.

Desirably, the felt wipes 440 are approximately the same length as the steel angles 412A and 412B which define the length of slot opening 414. This will allow the frothed additive composition to be spread equally across the dryer surface 23. It is noted that the length of the steel angles 412A, B is larger than the length of the dryer surface that is aligned the dryer's rotational axis. The distance of felt wipes 440 between the applicator lip 410 and the felt wipe's outermost edge 446 may be between about 0.2 cm to 50 cm.

Desirably the rectangular felt wipes 440 are identical in size and shape. The thickness of each wipe may range between 0.125 mm and 25.4 mm, or desirably between 3.0 mm and 10 mm.

Each of the felt wipes 440 are attached to a corresponding steel angle 412A and 412 B with a bar clamp 444. Desirably, fasteners such as metal screws (not shown) are spaced along the length of the bar clamp 444 for attachment to the steel angles. Desirably, the felt wipes 440 are made from polypropylene and Nylon fibers available from Albany International, located in Homer, N.Y., U.S.A. However, the felt wipe can be made from any other heat resistant sheet materials, such as metals, polymers (i.e. Teflon®), ceramic coated materials, natural based materials, etc.

Referring to FIG. 11, in one embodiment, the applicator 24 is fitted with end dams 450, located on each side of the applicator lip. The end dams 450 are identical in shape and size, and are used to block frothed chemistry from flowing out in a cross-direction between the felt wipes 440. Each end dam is constructed from a material that is not negatively affected by the dryer heat and additive chemistry.

Desirably, end dam 450 is a quasi-rectangular block in that one surface 454 shares the same curvature of the dryer surface 23, and an opposite surface that is slotted from side to side. The slot 452 is T-shaped as defined by the inner surface of the end dam 450. Specifically, the inner surface of end dam 450 is shaped so that it can slide over not only the steel angles 412A and 412 B, but also, bar clamps 444.

As can be seen in FIG. 11, when end dams 450 are used, the steel angles 412A and 412B are extended beyond the felts 440 to at least the length corresponding to the end dam length 456. The end dams may be fastened into place by set screws. Further, the end dams are positioned against the edge of the felt wipes.

Optionally, a shim (not shown) can be used to contain a flow of froth to the dryer surface and/or reinforce the felt wipes. Therefore, the shim(s) can be located next to the felt wipe(s) or in the place of the felt wipe (s).

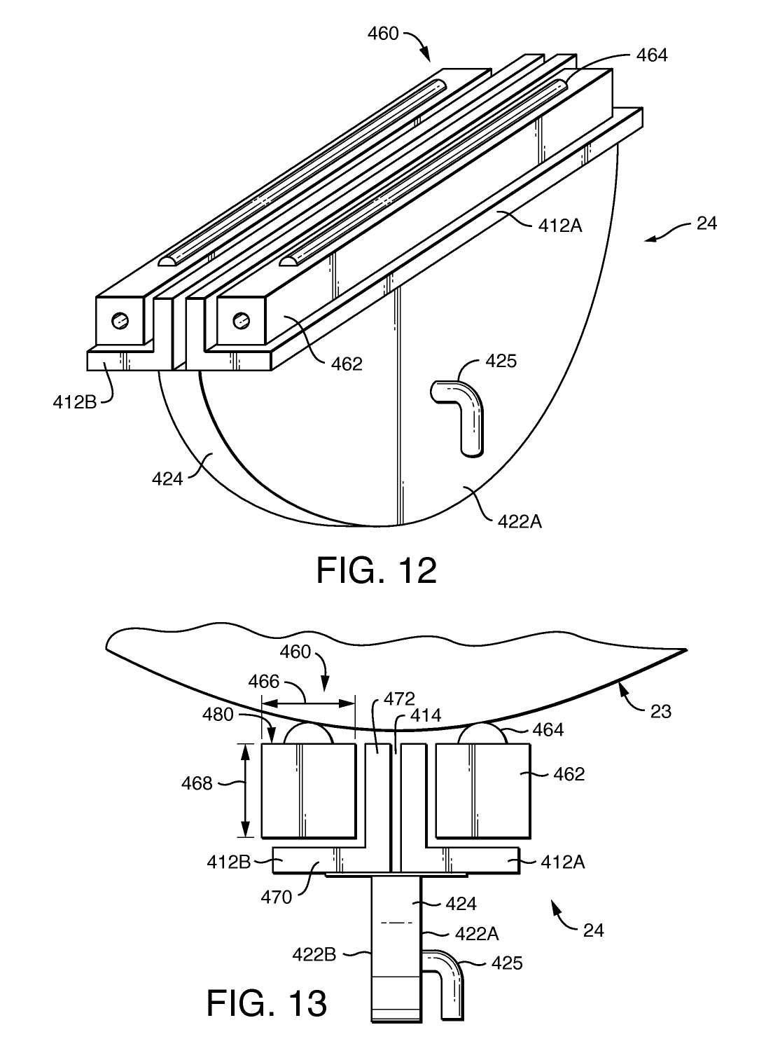

Referring now to FIGS. 12 and 13, in one embodiment of the present invention, rollers 460 are used to minimize overflow of froth coming from applicator 24. The rollers 460 include a roller casing 462 and a roller member 464.

The roller casing 462 is an elongated rectangular tube that has a width 466 that fits against the lower arm 470 of a steel angle 412 (e.g. 412 B) and has a height that is flush with the applicator lip (upper arm 472 of a steel angle 412). In the upper-most face 480 of each casing 462 is a slot that is dimensioned to allow the roller member 464 to partially protrude so that it may be placed in contact with the dryer 23 surface.

Generally, the roller members 464 are longer than the width of the substrate. When placed against the dryer 23 surface, the roller member 464 creates a barrier that prohibits the overflow of froth coming from the applicator 24. The roller member 464, being in contact with the dryer 23, is driven by the rotational speed of the dryer 22.

Creping Process: Creping is part of the substrate manufacturing process wherein the substrate is scraped off the surface of a rotating dryer (e.g. a Yankee Dryer) via a doctor blade assembly.

Shown in FIG. 3 is a simple example of the application of an additive composition being applied as part of an offline creping process. An applicator 109 applies the frothed additive composition of the present invention to the surface of the dryer drum 108. Due to equipment restriction, applicator 109 is positioned at the bottom of the dryer drum 22 at a “six o-clock position.” The applicator lip has to be positioned as close to the dryer surface as possible. In one aspect, the acceptable distance will be in a range from 0.5 mm to 50 mm. This allows the frothed chemicals to come in direct contact to the dryer surface 23.

From the tissue roll 85, a dried tissue web 80 proceeds toward the dryer drum 108 for conversion to a coated tissue. A press roll 110 provides the needed pressure for adhering web 85 to the outer surface of dryer 108. The additive composition adheres the tissue web 80 to the surface of the dryer drum 108. The additive composition is transferred to the tissue web as the web is creped from the drum using a creping blade 112. Once creped from the dryer drum 108, the tissue web 80 is wound into a roll 116.

### EXAMPLES

The following examples were prepared to demonstrate the process feasibility and product benefits. All the examples were prepared using the procedure as described. Substrates, additive chemistries (“add-ons”), and process parameters are listed in tables corresponding to each example.

### Example 1

In this example, three dry substrates were used: 54 gsm hydroentangled material (85% cellulose and 15% spunbond), obtainable from Kimberly-Clark Professional, WYPALL X-50 hydroentangled wipers, 42 gsm UCTAD bath tissue and 17 gsm facial tissue. (The facial tissue base sheets were not run up to 1000 fpm.) The dry substrates were treated in an offline creping process.

A commercial HYPOD dispersion was diluted to a solid level by mill water that was pre-treated by the addition of Na₂CO₃ at a level of 2 g per 10 kg water, and then frothed by a Gaston CFS 10 inch Foam Generator. In some aspects, a foaming agent was used. One foaming agent is hydroxypropyl cellulose which serves to enhance froth stability. This material may be available from Ashland, Inc., Wilmington, Del., U.S.A, and is sold under the KLUCEL brand. The stable froth was applied onto a hot Yankee dryer surface and then directly bonded with the dry substrate by a pressure roll.

The treated substrate was then scraped off the Yankee dryer surface after the froth cured. Curing should take place in the time defined by the machine speeds listed in Table 1. The Yankee dryer had a diameter of 72 inches and heated to a surface temperature of about 300° F.

TABLE 1

| | | | | | Foam Unit Settings | | | Process Parameter | |
|---|---|---|---|---|---|---|---|---|---|
| | | Coating Composition | | | Flow | | | Yankee | Machine |
| | | (g/10 kg dispersion)** | | | Rate | Mixing | Blow | Temp. | Speed |
| Code | Substrate | HYPOD | KLUCEL* | Na₂CO₃ | (l/min) | (%) | Ratio | (° F.) | (ft/min) |
| 1 | HYDROKNIT | 4762 | 50 | 2 | 1000 | 50 | 15 | 300 | 500 |
| 2 | HYDROKNIT | 4762 | 50 | 2 | 1000 | 50 | 15 | 300 | 750 |
| 3 | HYDROKNIT | 4762 | 0 | 2 | 1000 | 50 | 15 | 300 | 1000 |
| 4 | UCTAD | 4762 | 0 | 2 | 1000 | 50 | 15 | 300 | 250 |
| 5 | UCTAD | 4762 | 0 | 2 | 1000 | 50 | 15 | 300 | 500 |
| 6 | UCTAD | 2381 | 0 | 2 | 1000 | 50 | 15 | 300 | 500 |
| 7 | UCTAD | 4762 | 0 | 2 | 1000 | 50 | 15 | 300 | 750 |
| 8 | UCTAD | 2381 | 0 | 2 | 1000 | 50 | 15 | 300 | 1000 |
| 9 | UCTAD | 4762 | 0 | 2 | 1000 | 50 | 15 | 300 | 1000 |
| 10 | Facial Tissue | 2381 | 0 | 2 | 1000 | 50 | 15 | 300 | 50 |

*HYPOD is a 42 wt % aqueous dispersion from Dow and KLUCEL is hydroxypropyl cellulose available from Ashland, Inc. with a designation of K.
**Water will be added to make up to 10 kg dispersion.

### Example 2

In this group of samples, dry UCTAD tissue with a basis weight of 42 gsm was treated in an offline creping process. Coating chemistries were diluted to different solid levels by mill water that was pre-treated by addition of Na₂CO₃ at a level of 2 g per 10 kg water. The dilution was then frothed by the Gaston foam generator. The froth was applied onto hot Yankee dryer surface of (the same dryer of Example 1) and then bonded to the dry UCTAD sheet by a pressure roll. The treated UCTAD sheets were then scraped off the Yankee dryer surface after the add-ons were cured at a temperature listed in Table 2.

TABLE 2

| | | Coating Composition | | | | | | | Process Parameter | |
|---|---|---|---|---|---|---|---|---|---|---|
| | | (g/10 kg dispersion)*** | | | | Foam Unit Settings | | | Yankee | Machine |
| | | DPOD | | | | Flow Rate | Mixing | Blow | Temp. | Speed |
| Code | Substrate | Type* | Amount | KLUCEL** | Na₂CO₃ | (ml/min) | (%) | Ratio | (° F.) | (ft/min) |
| 1 | UCTAD | HYPOD | 7142 | 0 | 2 | 1000 | 50 | 10 | 300 | 50 |
| 2 | UCTAD | HYPOD | 4762 | 0 | 2 | 1000 | 50 | 10 | 300 | 50 |
| 3 | UCTAD | HYPOD | 2381 | 0 | 2 | 1000 | 50 | 10 | 300 | 50 |
| 4 | UCTAD | HYPOD | 1190 | 0 | 2 | 1000 | 50 | 10 | 300 | 50 |
| 5 | UCTAD | HYPOD | 1190 | 25 | 2 | 1000 | 50 | 10 | 300 | 50 |
| 6 | UCTAD | HYPOD | 595 | 0 | 2 | 1000 | 50 | 10 | 300 | 50 |
| 7 | UCTAD | HYPOD | 595 | 12.5 | 2 | 1000 | 50 | 10 | 300 | 50 |
| 8 | UCTAD | 80/20 | 5454 | 0 | 2 | 1000 | 50 | 10 | 300 | 50 |
| 9 | UCTAD | 80/20 | 3636 | 0 | 2 | 1000 | 50 | 10 | 300 | 50 |
| 10 | UCTAD | 80/20 | 1818 | 0 | 2 | 1000 | 50 | 10 | 300 | 50 |
| 11 | UCTAD | 80/20 | 909 | 0 | 2 | 1000 | 50 | 10 | 300 | 50 |

*HYPOD contains 60% AFFINITY and 40% PRIMACOR; the 80/20 chemistry contains 80% AFFINITY and 20% PRIMACOR, with a solid level of 55 wt % and a viscosity around 100 cps.
**KLUCEL is hydroxypropyl cellulose available from Ashland, Inc., with a designation of K.
***Water will be added to make up to 10 kg dispersion.

### Example 3

This is the first example that demonstrates the feasibility of frothed chemistry on a pilot tissue machine that operates at a speed that is near that of a commercial tissue machine. Two additive compositions were tried: (1) a creping chemistry made with CREPETROL 870 (90 percent) and CREPETROL 874 (10 percent): it is 25% solid liquid and available from Ashland, Inc. located in Wilmington, Del., U.S.A., and (2) commercial polyolefin dispersion, HYPOD 8510, a 42% solid dispersion available from the Dow Chemical Company. The dispersion had about 1 micron average particle size, melting point of 63 C, and a glass transition of −53. Both chemistries were frothed before applied onto hot Yankee dryer surface. The dryer has a diameter of 96 inches. A foaming agent, UNIFROTH 0800, a 38% solid liquid, available from UniChem Inc, was used to stabilize the frothed dispersions of the above two.

TABLE 3

| | | Coating Composition | | | | | | | Process | |
|---|---|---|---|---|---|---|---|---|---|---|
| | | Coatings | | | | | | | Parameter | |
| | | Creping | | UNIFROTH | | Froth Unit Settings | | | Yankee | Machine |
| | Facial Tissue | Chemistry | HYPOD | 0800* | Water | Flow Rate | Mixing | Blow | Temp. | Speed |
| Code | Composition | (liter) | (liter) | (liter) | (liter) | (ml/min) | (%) | Ratio | (° F.) | (ft/min) |
| 1 | 70% Euc/30% Pictou | 17.01 | | 2.45 | 75.04 | 300 | 50 | 10 | 550 | 2000 |
| 2 | 70% Euc/30% Pictou | | 10.8 | 2.32 | 77.6 | 300 | 50 | 10 | 550 | 2000 |
| 3 | 70% Euc/30% Pictou | | 10.8 | 2.32 | 77.6 | 150 | 50 | 20 | 550 | 2000 |
| 4 | 70% Euc/30% Pictou | | 10.8 | 2.32 | 77.6 | 150 | 50 | 15 | 550 | 2000 |
| 5 | 70% Euc/30% Pictou | | 10.8 | 2.32 | 77.6 | 150 | 50 | 10 | 550 | 2000 |
| 6 | 70% Euc/30% Pictou | | 10.8 | 2.32 | 77.6 | 100 | 50 | 8 | 550 | 2000 |
| 7 | 70% Euc/30% Pictou | | 10.8 | 2.32 | 77.6 | 100 | 50 | 8 | 550 | 2000 |

Note:
*UNIFROTH 0800 is an anionic surfactant with a solid level of 38% available from UniChem Inc.

### Example 4

In this example, dry substrates were used and treated in an offline creping process. Commercial HYPOD dispersion was diluted with mill water to a solid level which was pre-treated by addition of Na₂CO₃ at a level of 2 g per 10 kg water and then frothed by the Gaston unit, supra. The stable froth was applied to the hot drum surface of the 72 inch Yankee dryer and adhered to the dry substrate with a pressure roll. The treated substrates were then scraped off the Yankee surface after the chemistries were cured for the times and temperatures listed in Table 4. Three dry substrates were used in this example: Spunbond and BCW nonwovens, and a 42 gsm UCTAD tissue. The spunbond is made of a bicomponent, fiber and has a basis weight of 18 gsm. The BCW, has a basis weight of 20 gsm. The bicomponent fiber may be a PP/PE (Polypropylene/Polyethylene) side-by-side spunbond bicomponent fiber. See for example U.S. Pat. No. 5,382,400, incorporated herein to the extent it does not conflict with the present invention.

TABLE 4

| | | | | | | | | | Process | |
|---|---|---|---|---|---|---|---|---|---|---|
| | | | | | | Froth Unit Settings | | | Parameter | |
| | | Coating Composition | | | | Flow | | | Yankee | Machine |
| | | Coatings | | HYPOD | Water | Rate | Mixing | Blow | Temp. | Speed |
| Code | Substrates | Type | Solids | (kg) | (kg) | (ml/min) | (%) | Ratio | (° F.) | (ft/min) |
| 1 | Spunbond | HYPOD | 30% | 26.5 | 10.6 | 300 | 30 | 10 | 250 | 50 |
| 2 | Spunbond | HYPOD | 20% | 18.9 | 20.8 | 300 | 50 | 8 | 280 | 50 |
| 3 | Spunbond | HYPOD | 10% | 7.5 | 24.2 | 300 | 50 | 8 | 300 | 50 |
| 4 | BCW | HYPOD | 30% | 26.5 | 10.6 | 300 | 30 | 10 | 250 | 50 |
| 5 | BCW | HYPOD | 20% | 18.9 | 20.8 | 300 | 35 | 10 | 250 | 50 |
| 6 | BCW | HYPOD | 10% | 7.5 | 24.2 | 300 | 50 | 10 | 300 | 50 |
| 7 | UCTAD | HYPOD | 30% | 26.5 | 10.6 | 300 | 30 | 10 | 250 | 50 |
| 8 | UCTAD | HYPOD | 20% | 18.9 | 20.8 | 300 | 35 | 10 | 250 | 50 |
| 9 | UCTAD | HYPOD | 10% | 7.5 | 24.2 | 300 | 50 | 10 | 300 | 50 |

### Example 5

In this example, coating chemistries were frothed and applied onto the drum of a Yankee dryer in an inline fashion. The dryer had a diameter of 24 inches. Using a pressure roll, the film resulting from applying the frothed add-on to the dryer was then contacted with the wet cellulose pulp sheet having a consistency of around 40% solids by weight.

There were four different pulps used in this example. Two pulps were the same as that used to make a Kimberly-Clark standard facial tissue: Eucalyptus and Pictou fiber (Northern soft wood kraft), while other two pulps were of lower comparative cost and quality: Southern Alabama Pine (SAP) and SFK recycled fiber available from SFK Pulp Recycling U.S. Inc. In general, facial tissue produced from the lower cost pulp tends to have less softness. It is desirable to use a HYPOD surface coating to make a low cost pulp tissue product that has parity or even improved softness as a standard facial tissue made with conventional creping chemistry.

The wet sheet with different combinations of the different pulps was dried on the hot Yankee surface together with the additive chemistry and then scraped off the drum surface. Samples 1 to 3 are not surface coated with the frothed chemicals. Sample 1 was a control facial tissue produced in the same way as a Kimberly-Clark standard facial tissue product. Samples 2 and 3 were control samples for low cost pulp facial tissues which were produced in the same way as a Kimberly-Clark standard facial tissue. All of the control samples were produced by spraying unfrothed creping chemistries onto the dryer drum. The creping chemistry was prepared by mixing 2500 ml of 6% polyvinyl alcohol, 100 ml of 12.5% KYMENE, and 15 ml of 7.5% REZOSOL in 25 gallons of mill water.

For examples 4 through 9, HYPOD was diluted to different levels of solids and mixed with additional foaming agent, either KLUCEL or UNIFROTH 0800, before each dispersion was frothed by the Gaston foam generator (supra) and applied onto the dryer for the surface coating treatment.

TABLE 5

| | | | | | | Foam Unit Settings | | | Process Parameter | | |
|---|---|---|---|---|---|---|---|---|---|---|---|
| | | Coating Composition g/10 kg dispersion)* | | | | Flow | | | Sheet | Machine | Tissue |
| | Facial Tissue | | | UNIFROTH | | Rate | Mixing | Blow | Temp. | Speed | GMT |
| Code | Composition | HYPOD | KLUCEL | 0800 | Na₂CO₃ | (ml/min) | (%) | Ratio | (° F.) | (ft/min) | (gf) |
| 1 | 70% Euc/30% Pictou | NA | NA | NA | NA | NA | NA | NA | 239 | 60 | 809 |
| 2 | 70% Euc/30% SAP | NA | NA | NA | NA | NA | NA | NA | 237 | 60 | 941 |
| 3 | 75% SFK/25% Euc | NA | NA | NA | NA | NA | NA | NA | 237 | 60 | 771 |
| 4 | 70% Euc/30% Pictou | 1190 | 0 | 65.8 | 0 | 180 | 50% | 25 | 260 | 60 | 620 |
| 5 | 70% Euc/30% Pictou | 1190 | 0 | 65.8 | 0 | 150 | 50% | 25 | 259 | 60 | 573 |
| 6 | 70% Euc/30% Pictou | 595 | 0 | 65.8 | 2 | 180 | 50% | 25 | 259 | 60 | 672 |
| 7 | 70% Euc/30% Pictou | 595 | 6 | 0 | 2 | 150 | 50% | 25 | 259 | 60 | 644 |
| 8 | 70% Euc/30% SAP | 595 | 6 | 0 | 2 | 180 | 50% | 25 | 259 | 60 | 632 |
| 9 | 75% SFK/25% Euc | 595 | 6 | 0 | 2 | 150 | 50% | 25 | 259 | 60 | 692 |

Note:
*Water will be added to make up to 10 kg dispersion.

### Example 6

In this example, dry substrates were used and treated in an offline creping process. The Yankee dryer had a diameter of 72 inches. There were two groups of coating chemistries used in this study: dispersions and solutions. Table 6 summarizes the group of water soluble solution chemistries and mixture solution solids levels. For this group, we had to pre-dissolve each add-on to form a solution, and then prepare mixtures from each solution. The commercial HYPOD dispersion was also diluted to different solid levels. The solutions and dispersions prepared were frothed by the Gaston foam generating unit and applied onto the hot dryer drum surface. The resulting film then contacted the dry substrate by a pressure roll. The treated substrates were then scraped off the Yankee surface after the chemistries were cured for certain time at temperatures listed in Table 7. Four dry substrates were used in this group: 18 gsm Spunbond, 42 gsm UCTAD bath tissue, and 14.1 gsm facial tissue.

Table 6 contains information of two types of polymer solutions: five pre-prepared solutions listed on the left side of the table, and three mixtures of the pre-prepared solutions. These three mixtures are R1, R2 and R3. For example, R1 is a mixture solution prepared by mixing three pre-prepared solutions (45% of pre-prepared 10% glucosol, 40% of pre-prepared 40% PEG, and 15% of pre-prepared 2% Polyox). The mixture solution has a solid level of 20.8% which is resulted from the equation of 45%*10%+40%*40%+15%*2%=20.8%. Mixture solids for R2 and R3 are calculated the same way as the R1's.

TABLE 6

| Pre-prepared Solutions (wt %) | | Mixture of Solutions (wt %) | | |
|---|---|---|---|---|
| Polymer Type | Solids | R1 | R2 | R3 |
| Glucosol: hydroxypropyl starch | 10% | 45% | 65% | 40% |
| PEG: polyethylene glycol | 40% | 40% | | |
| Polyox: polyethylene oxide | 2% | 15% | | |
| HEC: hydroxyethyl cellulose | 2% | | 35% | |
| PVOH: polyvinyl alcohol | 6% | | | 25% |
| HYPOD | 42% | | | 35% |

| | | | |
|---|---|---|---|
| Mixture Solids | 20.8% | 7.2% | 20.2% |

TABLE 7

| | | Coating Composition | | | | Froth Unit Settings | | | Process Parameter | | |
|---|---|---|---|---|---|---|---|---|---|---|---|
| | | g/10 kg dispersion | | | | Flow | | | | | Machine |
| | | Coatings | | | UNIFROTH | Rate | Mixing | Blow | Temp. (° F.) | | Speed |
| Code | Substrates* | Type | Solids | KLUCEL | 0800 | (ml/min) | (%) | Ratio | Dryer | Sheet | (ft/min) |
| 1 | Spunbond | HYPOD | 8333 | 0 | 0 | 250 | 30 | 7 | 265 | 220 | 50 |
| 2 | Spunbond | HYPOD | 8333 | 0 | 0 | 250 | 30 | 7 | 265 | 203 | 200 |
| 3 | Spunbond | HYPOD | 4762 | 0 | 0 | 300 | 30 | 10 | 265 | | 50 |
| 4 | Spunbond | HYPOD | 2381 | 0 | 0 | 200 | 30 | 15 | 265 | 198 | 50 |
| 5 | Spunbond | HYPOD | 595 | 14.8 | 0 | 200 | 30 | 15 | 270 | 214 | 50 |
| 6 | Spunbond | HYPOD | 2381 | 0 | 0 | 300 | 30 | 15 | 270 | 209 | 250 |
| 7 | Spunbond | HYPOD | 2381 | 0 | 0 | 200 | 30 | 15 | 280 | 224 | 50 |
| 8 | Spunbond | HYPOD | 595 | 14.8 | 0 | 200 | 30 | 15 | 280 | 218 | 50 |
| 9 | UCTAD | HYPOD | 4762 | 0 | 0 | 250 | 30 | 7 | 265 | 245 | 50 |
| 10 | UCTAD | HYPOD | 595 | 14.8 | 0% | 300 | 30 | 10 | 250 | 230 | 50 |
| 11 | Facial | R1 | 2403 | 0 | 526 | 150 | 40 | 15 | 270 | 228 | 50 |
| 12 | Facial | R2 | 2083 | 0 | 526 | 150 | 40 | 15 | 290 | 257 | 50 |
| 13 | Facial | R3 | 2357 | 0 | 0 | 300 | 40 | 5 | 285 | 250 | 50 |

### Example 7

A modification of froth applicator was made as described above. All such changes were intended to enhance the froth vertical velocity. This will reduce the probability that the froth will run off of the applicator's lip and not onto the dryer surface. One advantage of such a modification is to enable of the use of a lower flow rate to reduce the amount of coating without lowering the solids level.

A lower amount of the additive composition may be achieved by reducing the HYPOD solid levels. HYPOD was diluted to a solid level of 5% or lower so that lower levels of additive composition were disposed on the tissue substrate. However, as mentioned above, the unique microporous structure of the froth is formed largely due to high viscosity and high solids of coating chemistries. The modification of the applicator allows the reduction of additive composition levels on the tissue without compromising the formation of the unique frothed tissue structure of the present invention. The samples of Table 8 summarize the operating conditions used with the modified applicator. Codes 1 and 2 were made with a conventional creping chemistry listed in Example 5. Codes 3-7 were made with frothed HYPOD.

TABLE 8

| | | Coating Composition | | | | | Process Parameter | | |
|---|---|---|---|---|---|---|---|---|---|
| | | | Amount | Foam Unit Settings | | | | Machine | Tissue |
| | | | (g/10 kg | Flow Rate | Mixing | Blow | Sheet Temp. | Speed | GMT |
| Code | Facial Tissue Composition | HYPOD | dispersion) | (ml/min) | (%) | Ratio | (° F.) | (ft/min) | (gf) |
| 1 | 70% Euc/30% Pictou | NA | NA | NA | NA | NA | 239 | 60 | 812 |
| 2 | 100% recycled fiber RFK | NA | NA | NA | NA | NA | 239 | 60 | 844 |
| 3 | 70% Euc/30% Pictou | 8510 | 7143 | 100 | 50 | 12 | 257 | 60 | 911 |
| 4 | 70% Euc/30% Pictou | 8510 | 7143 | 100 | 30 | 6 | 257 | 60 | 835 |
| 5 | 100% recycled fiber RFK | 8510 | 7143 | 100 | 30 | 6 | 257 | 60 | 978 |
| 6 | 100% recycled fiber RFK | 8510 | 4762 | 100 | 30 | 5 | 260 | 60 | 1001 |
| 7 | 70% Euc/30% Pictou | 8510 | 4762 | 100 | 30 | 6 | 257 | 60 | 900 |

Pictou is classified as Northern soft wood kraft pulp.
RFK is 100% recycled fiber grade available from SFK (supra).

Sensory Panel Evaluation Results:

Study I:

This study was performed to determine softness per the In-Hand Ranking Test for Tactile Properties (IHR test). In this study, four tissue materials were selected. The following codes from Example 1 were tested: untreated facial and UCTAD bath tissues, a facial tissue treated with HYPOD (code 10, Table 1), and UCTAD tissues (code 8, Table 1). Each facial tissue code was a 2-ply facial tissue with either (1) the coated surface (also the creped side) facing outside so that the user can only touch the softer and smoother side. One-ply UCTAD tissue was also tested, but only has one creped side in accordance with the present invention. The IHR test only uses the treated side(s).

Table 9 summarizes the four codes that were the subjects of this study. The tissue content of HYPOD was determined by measuring the potassium content of the tissue samples versus the HYPOD dry polymer potassium content. (The HYPOD PRIMACOR component is potassium polyacrylate).

TABLE 9

| | | HYPOD Content | |
|---|---|---|---|
| Code | Description | (%) | mg/m² |
| Control facial | 14 gsm 2 ply facial | 0 | 0 |
| | tissue | | |
| HYPOD facial | 14 gsm 2 ply HYPOD | 16.8 | 1176 |
| | treated facial tissue | | |
| Control | 43 gsm 1 ply UCTAD | 0 | 0 |
| (UCTAD) | | | |
| HYPOD UCTAD | 43 gsm 1 ply HYPOD | 2.6 | 1118 |
| | treated UCTAD | | |

Refer to Table 1 for additional code information

Sensory Panel Results: Two separate sensory panel studies were conducted: one for the facial tissue product of the present invention and the other for the UCTAD bath tissue. The softness results are listed in Tables 10 and 11.

TABLE 10

| | Overall | | Standard | 95% |
|---|---|---|---|---|
| Code | Probability | Log Odds | Error | Grouping |
| HYPOD Facial | 91.7 | 0.0000 | 0.6030 | A |
| Tissue | | | | |
| Control Facial | 8.3 | −2.3978 | 0.6030 | B |
| Tissue | | | | |

TABLE 11

| | Overall | | Standard | 95% |
|---|---|---|---|---|
| Code | Probability | Log Odds | Error | Grouping |
| UCTAD | 94.4 | 0.0000 | 0.7276 | A |
| Tissue With | | | | |
| HYPOD | | | | |
| UCTAD | 5.6 | −2.8332 | 0.7276 | B |
| Control | | | | |

The results show that the surface treatment of the present invention improved tissue softness by the log odds of 2, meaning that it feels 100 times softer. Both HYPOD treated facial and UCTAD tissues performed better than their respective controls with a 95% confidence.

Study II:

Tissue Product Codes: Six tissue materials were selected from Example 5 and converted into 2-ply facial tissues. Both sides of the tissues were treated and faced outward. Table 12 summarizes the six codes with HYPOD add-on data. The tissue content of HYPOD was determined by measuring the potassium content of the tissue samples versus the HYPOD dry polymer potassium content. (The HYPOD PRIMACOR component is potassium polyacrylate).

TABLE 12

| | | HYPOD Content | |
|---|---|---|---|
| Code | Description | (%) | mg/m² |
| Standard facial tissue | 14 gsm 2 ply facial tissue converted | 0 | 0 |
| Control | from Code 1 of Example 5 | | |
| SAP facial tissue | 14 gsm 2 ply facial tissue converted | 0 | 0 |
| Control | from Code 2 of Example 5 | | |
| SFK tissue | 14 gsm 2 ply facial tissue converted | 0 | 0 |
| controlControl | from Code 3 of Example 5 | | |
| Standard Pictou | 14 gsm 2 ply facial tissue converted | 2.75 | 195 |
| | from Code 8 of Example 5 | | |
| HYPODSAP | 14 gsm 2 ply facial tissue converted | 3.07 | 218 |
| | from Code 8 of Example 5 | | |
| HYPOD SFK | 14 gsm 2 ply facial tissue converted | 2.47 | 176 |
| | from Code 9 of Example 5 | | |

SFK is 100% recycle fiber upgrade from SFK

Sensory Panel Results are listed in Table 13:

TABLE 13

| | Overall | | Standard | 95% |
|---|---|---|---|---|
| Code | Probability | Log Odds | Error | Grouping |
| Mainline | 54.1 | 1.6920 | 0.4106 | A |
| SAP | 34.1 | 1.2258 | 0.4439 | A |
| SFK | 9.9 | 0.0000 | 0.5326 | B |
| Mainline Control | 1.2 | −2.2185 | 0.5069 | C |
| SAP Control | 0.7 | −3.0225 | 0.5744 | C |
| SFK Control | 0.0 | −6.3712 | 0.7762 | E |

### Example 8

In this example, additive compositions were either frothed or diluted before they were applied to the Yankee dryer. The application of the additive compositions was done in-line with a froth applicator or a spraying boom. The froth applicator applied the additive chemistry to a Yankee dryer at a solid level of 20 wt %, and the liquid spraying boom (known in the prior art) applied the additive chemistry to a Yankee dryer at a less than 1 wt % solid level. (The Yankee dryer on which the film was formed had a diameter of 61 cm (24 inches).) The additive chemistry was heated and thus formed a film structure.

The wet sheets were dried on the hot Yankee dryer surface together with the additive chemistry (now a film), applied to the dryer as a frothed or sprayed HYPOD. Using a pressure roll, the film was directly bonded to the dried wet cellulose-pulp sheets containing about 40% solids by weight. (The pulps used for these two codes were Eucalyptus and Pictou fiber (Northern soft wood kraft). The coated tissue was then creped by scraping the tissue off of the dryer surface.

Code 1 was the product produced by with the frothed HYPOD surface treatment of the present invention, while Sample 2 was produced with the sprayed HYPOD surface treatment. Code 2 was used as a control of current facial tissue manufacturing technology. The amount of additive chemistries applied to the tissues was about the same for both codes. The additive (“coating”) composition data in Table 14 indicates that they were substantially close, with the sprayed code slightly higher. The two codes were both surface treated by the same additive chemistry by using the two different methods of application. Any difference of softness between the two codes (per the IHR test), is due to the very different structure of the additive composition as applied to the samples. See FIG. 6.

TABLE 14

| | | Coating | | | | | | | Process | | | |
|---|---|---|---|---|---|---|---|---|---|---|---|---|
| | | Composition | | Spraying Settings | | | | | Parameter | | | |
| | | (g/10 kg | | | Boom | Foam Unit Settings | | | Sheet | Machine | | HYPOD |
| | Facial Tissue | dispersion)* | | Number | Pressure | Flow Rate | Mixing | Blow | Temp. | Speed | Tissue | Add-on |
| Code | Composition | HYPOD | Na₂CO₃ | of Tips | (psi) | (ml/min) | (%) | Ratio | (° F.) | (ft/min) | GMT (gf) | (mg/m²) |
| 1 | 70% | 4760 | 2 | NA | NA | 100 | 30 | 6 | 257 | 60 | 900 | 1270 |
| | Euc/30% | | | | | | | | | | | |
| | Pictou | | | | | | | | | | | |
| 2 | 70% | 233 | 2 | 3 | 100 | NA | NA | NA | 250 | 60 | 756 | 1453 |
| | Euc/30% | | | | | | | | | | | |
| | Pictou | | | | | | | | | | | |

Note:
*water will be added to make up to 10 kg dispersion.

Study III:

Tissue Product Codes: Two tissue materials were selected from Example 8 and converted into facial tissue products. The resulting facial tissue after was a 2-ply product with the treated side facing outward. Therefore, each surface of the facial tissues was treated.

Sensory Panel Results: A sensory panel study was conducted on these two facial tissues. The softness results are listed in Tables 15. The results indicate that the facial tissue with the frothed HYPOD surface treatment is significantly softer than the tissue having the sprayed HYPOD surface treatment.

TABLE 15

| | Overall | | Standard | 95% |
|---|---|---|---|---|
| Code | Probability | Log Odds | Error | Grouping |
| Code 1 from | 65.8 | 0.0000 | 0.5127 | A |
| Table 14 | | | | |
| Code 2 from | 13.5 | −1.585 | 0.3944 | B |
| Table 14 | | | | |

Test Methods

(1) In-Hand Ranking Test for Tactile Properties (IHR Test):

The In-Hand Ranking Test (IHR) is a basic assessment of in-hand feel of fibrous webs and assesses attributes such as softness. This test is useful in obtaining a quick read as to whether a process change is humanly detectable and/or affects the softness perception, as compared to a control. The difference of the IHR softness data between a treated web and a control web reflects the degree of softness improvement.

A panel of testers was trained to provide assessments more accurately than an average untrained consumer might provide. Rank data generated for each sample code by the panel were analyzed using a proportional hazards regression model. This model computationally assumes that the panelist proceeds through the ranking procedure from most of the attribute being assessed to least of the attribute. The softness test results are presented as log odds values. The log odds are the natural logarithm of the risk ratios that are estimated for each code from the proportional hazards regression model. Larger log odds indicate the attribute of interest is perceived with greater intensity.

Because the IHR results are expressed in log odds, the difference in improved softness is actually much more significant than the data indicates. For example, when the difference of IHR data is 1, it actually represents 10 times (10¹=10) improvement in overall softness, or 1,000% improvement over its control. In another example, if the difference is 0.2, it represents 1.58 times (10^{0.2}=1.58) or a 58% improvement.

The data from the IHR can also be presented in rank format. The data can generally be used to make relative comparisons within tests as a product's ranking is dependent upon the products with which it is ranked. Across-test comparisons can be made when at least one product is tested in both tests.

(2) Sheet Bulk Test

Sheet bulk is calculated as the quotient of the sheet caliper of a conditioned fibrous sheet, expressed in microns, divided by the conditioned basis weight, and expressed in grams per square meter. The resulting sheet bulk is expressed in cubic centimeters per gram. More specifically, the sheet caliper is the representative thickness of a single sheet measured in accordance with TAPPI test methods T402 “Standard Conditioning and Testing Atmosphere For Paper, Board, Pulp Handsheets and Related Products” and T411 om-89 “Thickness (caliper) of Paper, Paperboard, and Combined Board” with Note 3 for stacked sheets. The micrometer used for carrying out T411 om-89 is an Emveco 200-A Tissue Caliper Tester available from Emveco, Inc., Newberg, Oreg., U.S.A. The micrometer has a load of 2 kilo-Pascals, a pressure foot area of 2500 square millimeters, a pressure foot diameter of 56.42 millimeters, a dwell time of 3 seconds and a lowering rate of 0.8 millimeters per second.

(3) Viscosity Test

Viscosity is measured using a Brookfield Viscometer, model RVDV-II+, available from Brookfield Engineering Laboratories, Middleboro, Mass., U.S.A. Measurements are taken at room temperature (23 C), at 100 rpm, with either spindle 4 or spindle 6, depending on the expected viscosity. Viscosity measurements are reported in units of centipoise.

(4) Quantity of HYPOD Additive Composition Test

In one aspect of the invention, HYPOD add-on is determined by using acid digestion. Samples are wet ashed with enough concentrated sulfuric and nitric acid to destroy the carbonaceous material and isolate the potassium ions from the cellulosic matrix. The potassium concentration is then measured by atomic absorption. HYPOD add-ons are determined by referencing the potassium concentration of the HYPOD on the sample to bulk HYPOD measurements from a control HYPOD dispersion solution (LOTVB1955WC30, 3.53%).

(5) Method for Determining Content of Additive Composition in Tissue.

Samples were digested following EPA method 3010A. The method consists of digesting a known amount of material with Nitric Acid in a block digester and bringing it up to a known volume at the end of the digestion.

Analysis was performed on a flame atomic absorption spectrophotometer using EPA method 7610 dated July 1986, which is a direct aspiration method using an air/acetylene flame. The instrument used was a VARIAN AA240FS available from Aligent Technologies, Santa Clara, Calif., U.S.A.

The analysis was performed in the following manner: The instrument was calibrated with a blank and five standards. Calibration was followed with analyzing a second source standard to confirm the calibration standards. In this particular case, recovery was 97% (90-110% being acceptable). Next a digestion blank and a digestion standard were analyzed. In this particular case, the blank was less than 0.1 mg/l and the standard recovery was 93% (85-115% being acceptable). Samples were then analyzed and after every tenth sample a standard was run (90-110% being acceptable). At the end of entire analysis, a blank and standard were run.

What is claimed is:

1. A nonwoven substrate comprising:
a fibrous web defining a surface; and
a layer of an additive composition bonded to the fibrous web surface, wherein the additive composition has an exposed surface and comprises a foaming agent.

2. The nonwoven substrate of claim 1 wherein the fibrous web comprises cellulosic fibers.

3. The nonwoven substrate of claim 1 wherein the additive composition comprises a synthetic water-soluble polymer.

4. The nonwoven substrate of claim 1 wherein the additive composition comprises a water-soluble polymer selected from the group consisting of modified cellulose, modified starch, modified protein, chitosan, chitosan salts, carrageenan, agar, gellan gum and guar gum.

5. The nonwoven substrate of claim 1 wherein the water-soluble polymer comprises hydroxypropyl cellulose.

6. The nonwoven substrate of claim 1 wherein the additive composition comprises a water-soluble polymer selected from the group consisting of poly(acrylic acid) and salts thereof, poly(acrylate esters) and poly(acrylic acid) copolymers.

7. The nonwoven substrate of claim 1 wherein the fibrous web is selected from the group consisting of tissue, uncreped through air-dried tissue, paper toweling, hydroentangled web, spunbond, coform, bonded carded web, airlaid and film/laminate sheet and paper.

8. The nonwoven substrate of claim 1 wherein additive composition layer has air bubbles entrapped therein.

9. The nonwoven substrate of claim 1 wherein the additive composition comprises a copolymer of ethylene and acrylic acid or a polyethylene-octene copolymer or a combination thereof.

10. The nonwoven substrate of claim 1 wherein the additive composition comprises a water-insoluble polyolefin copolymer.

11. The nonwoven substrate of claim 10 wherein the additive composition was in the form of a dispersion comprising the water-insoluble polyolefin copolymer and water prior to its application onto the nonwoven substrate.

12. The nonwoven substrate of claim 1 wherein the additive composition further comprises a copolymer of ethylene and acrylic acid, wherein the copolymer is exposed at a surface.

13. A nonwoven substrate comprising:
a fibrous web defining a surface; and
a layer of an additive composition bonded to the fibrous web surface, wherein the layer comprises dispersion beads and wherein the layer has entrapped air bubbles.
